(19) United States
(12) Patent Application Publication
(10) Pub. No.: US 2013/0032585 A1
(43) Pub. Date: Feb. 7, 2013

(54) THERMAL HEAD

(71) Applicants: Takashi Aso, Kyoto (JP); Satoru Hamasaki, Kyoto (JP)

(72) Inventors: Takashi Aso, Kyoto (JP); Satoru Hamasaki, Kyoto (JP)

(73) Assignee: KYOCERA CORPORATION, Kyoto (JP)

(21) Appl. No.: 13/635,113

(22) PCT Filed: Apr. 22, 2011
(86) PCT No.: PCT/JP2011/059930

§ 371 Date: Sep. 14, 2012

(30) Foreign Application Priority Data
Apr. 26, 2010 (JP) 2010-101067

(51) Int. Cl. H05B 3/00

(52) U.S. Cl. 219/209

(57) ABSTRACT

A thermal head includes a head base having a substrate and a plurality of heat-generating sections arranged on or above the substrate, a circuit board, a drive IC disposed on or above the substrate or on or above the circuit board, the drive IC controlling energizing states of the heat-generating sections, and a cover member having electric conductivity, disposed at least above the circuit board. The circuit board has a plurality of signal wirings for supplying electric signals for operating the drive IC. A face on a circuit board side of the cover member has an inclined region located above the signal wiring. The inclined region is composed of at least one inclined surface which is inclined with respect to a face on an inclined region side of the signal wiring

### FIELD OF INVENTION

The present invention relates to a thermal head.

### BACKGROUND

In the past, as a printing device of a facsimile machine, a video printer, or the like, various thermal heads have been proposed. For example, in a thermal head described in Patent Literature 1, a plurality of heat-generating sections (heat-generating resistors) are arranged on or above a substrate (an insulating substrate). Drive ICs are connected to the plurality of heat-generating sections through individual electrodes. The drive ICs are made to control driving of the heat-generating section on the basis of an electric signal (recording data) supplied through a signal wiring of a circuit board (a flexible substrate).

### CITATION LIST

### Patent Literature

Patent Literature 1: Japanese Unexamined Patent Publication JP-A-9-207367(1997)

### SUMMARY

### Technical Problem

In the thermal head described in Patent Literature 1, a cover member (a head cover) is disposed above the circuit board. The cover member and the circuit board are formed such that surfaces facing each other are parallel. For this reason, the electric signal which is supplied through the signal wiring of the circuit board flows parallel to the surface facing the circuit board of the cover member, whereby so-called parallel plate resonance is generated, so that a high level of radiation noise is generated in a specific frequency. Due to this, there is a problem in that electromagnetic interference occurs.

The invention has been made in order to solve the above-described problem and has an object to reduce occurrence of electromagnetic interference in a thermal head including a circuit board.

### Solution to Problem

A thermal head according to an embodiment of the invention includes a head base having a substrate and a plurality of heat-generating sections arranged on or above the substrate, a circuit board, a drive IC disposed on or above the substrate or on or above the circuit board, the drive IC controlling energizing states of the heat-generating sections, and a cover member having electric conductivity, disposed at least above the circuit board. The circuit board has a plurality of signal wirings for supplying electric signals for operating the drive IC. A face on a circuit board side of the cover member has an inclined region located above the signal wiring. The inclined region is composed of at least one inclined surface which is inclined with respect to a face on an inclined region side of the signal wiring.

Further, a thermal head according to an embodiment of the invention includes a head base having a substrate and a plurality of heat-generating sections arranged on or above the substrate, a circuit board extending along an arrangement direction of the plurality of heat-generating sections, a drive IC disposed on or above the substrate or on or above the circuit board, the drive IC controlling energizing states of the heat-generating sections, and a cover member having electric conductivity, disposed at least above the circuit board. The circuit board has an electrically-conducting wiring which includes at least one of power supply wirings for supplying electric currents for making the plurality of heat-generating sections generate heat and signal wirings for supplying electric signals for operating the drive IC. The electrically-conducting wiring has a first region extending along a longitudinal direction of the circuit board. A face on a circuit board side of the cover member has an inclined region located above the first region of the electrically-conducting wiring. The inclined region is composed of at least one inclined surface which is inclined with respect to a face on an inclined region side of the first region.

### Advantageous Effects of Invention

According to the invention, in a thermal head including a circuit board, it is possible to reduce occurrence of electromagnetic interference.

### BRIEF DESCRIPTION OF THE DRAWINGS

FIG. 1 is a plan view showing an embodiment of a thermal head according to the invention;

FIG. 2 is a cross-sectional view taken along the line II-II of the thermal head in FIG. 1;

FIG. 3 is a cross-sectional view taken along the line III-III of the thermal head in FIG. 1;

FIG. 4 is a plan view showing the thermal head in FIG. 1 with the illustration of a cover member omitted;

FIG. 5 is an enlarged view of a fixed section of the cover member shown in FIG. 3 and a region in the vicinity thereof;

FIG. 6 is a cross-sectional view showing a modified example of the cover member shown in FIG. 3;

FIG. 7 is a cross-sectional view showing a modified example of the cover member shown in FIG. 3;

FIG. 8 is a cross-sectional view showing a modified example of the cover member shown in FIG. 3;

FIG. 9 is a diagram showing the position of a first inclined region in a face on an FPC side of the cover member in the plan view of the thermal head in FIG. 1; and

FIG. 10 is a diagram showing the positions of a second inclined region and a third inclined region in the face on the FPC side of the cover member in the plan view of the thermal head in FIG. 1.

### DETAILED DESCRIPTION OF THE PREFERRED EMBODIMENTS

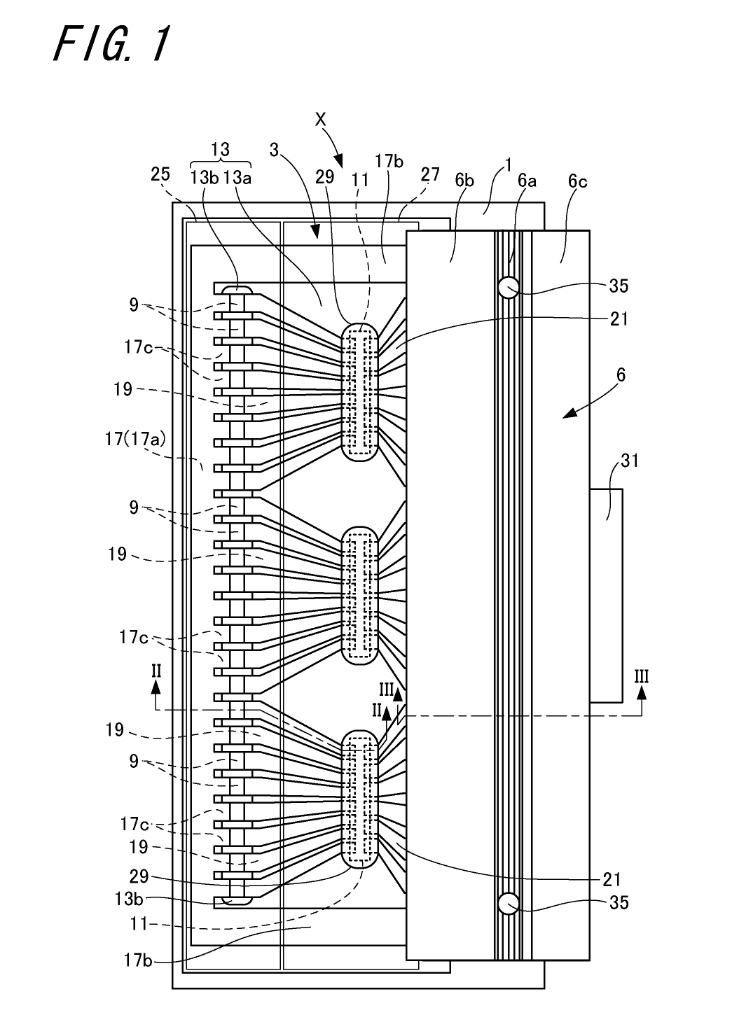

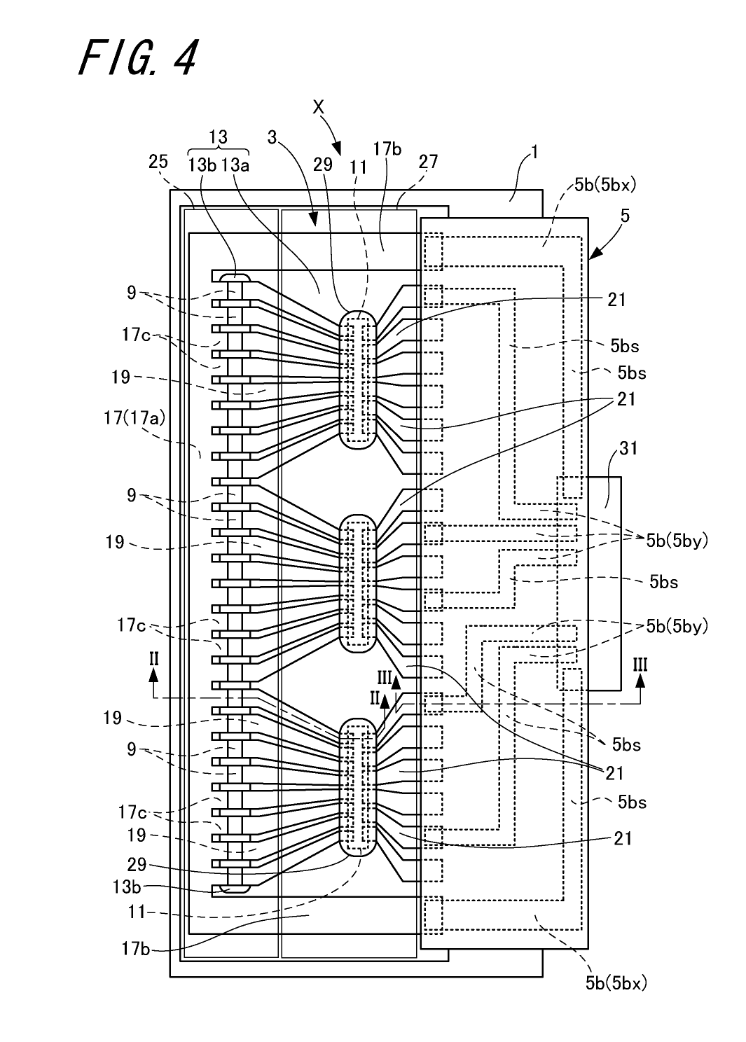

Hereinafter, an embodiment of a thermal head according to the invention will be described with reference to the drawings. As shown in FIGS. 1 to 4, a thermal head X of this embodiment includes a radiator 1, a head base 3 disposed on or above the radiator 1, a flexible printed circuit board 5 (hereinafter referred to as an FPC 5) connected to the head base 3, and a cover member 6 disposed above the FPC 5. In addition, FIG. 4 is a plan view showing the thermal head X with the illustration of the cover member 6 omitted.

The radiator 1 is formed in a plate shape and has a rectangular shape in plan view. The radiator 1 is formed of a metal material such as copper or aluminum, for example, and has a function to radiate some of the heat that does not contribute to printing, of heat generated in a heat-generating section 9 of the head base 3, as described later. Further, the head base 3 is adhered to the upper surface of the radiator 1 by a double-sided tape, an adhesive, or the like (not shown).

The head base 3 includes a substrate 7 having a rectangular shape in plan view, a plurality (in the illustrated example, 24 pieces) of heat-generating sections 9 disposed on or above the substrate 7 and arranged along a longitudinal direction of the substrate 7, and a plurality (in the illustrated example, 3 pieces) of drive ICs 11 disposed side by side on or above the substrate 7 along an arrangement direction of the heat-generating sections 9.

The substrate 7 is formed of an electrically insulating material such as alumina ceramics, a semiconductor material such as single-crystalline silicon, or the like.

On the upper surface of the substrate 7, a heat storage layer 13 is formed. The heat storage layer 13 has a base portion 13a formed on the entire upper surface of the substrate 7, and a raised portion 13b extending in a strip shape along the arrangement direction of the plurality of heat-generating sections 9 and having a cross-section of an approximately semi-elliptical shape. The raised portion 13b acts so as to make a recording medium which is to be printed be favorably pressed against a first protective layer 25 (described later) formed on or above the heat-generating sections 9.

Further, the heat storage layer 13 is formed of, for example, glass having low thermal conductivity and acts so as to temporarily store some of the heat which is generated in the heat-generating sections 9, thereby shortening time required to raise the temperature of the heat-generating sections 9 and enhancing the thermal response characteristics of the thermal head X. The heat storage layer 13 is formed, for example, by applying given glass paste obtained by mixing a suitable organic solvent with glass powder, to the upper surface of the substrate 7 by well-known conventional screen printing or the like, and then firing it at high temperature.

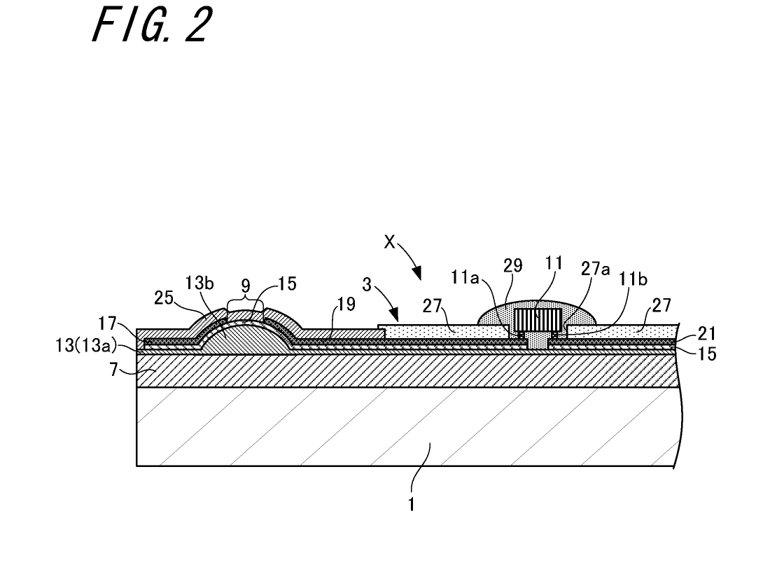

As shown in FIG. 2, on the upper surface of the heat storage layer 13, an electrical resistance layer 15 is disposed. The electrical resistance layer 15 is interposed between the heat storage layer 13 and a common electrode wiring 17, an individual electrode wiring 19, and an IC-FPC connection wiring 21, which will be described later, and has regions (hereinafter referred to as interposition regions) having the same shapes as those of the common electrode wiring 17, the individual electrode wiring 19, and the IC-FPC connection wiring 21 in plan view, and a plurality (in the illustrated example, 24 pieces) of regions (hereinafter referred to as exposed regions) exposed from between the common electrode wiring 17 and the individual electrode wiring 19, as shown in FIGS. 1 and 4. In addition, in FIGS. 1 and 4, the interposition regions of the electrical resistance layer 15 are concealed by the common electrode wiring 17, the individual electrode wiring 19, and the IC-FPC connection wiring 21.

Each of the exposed regions of the electrical resistance layer 15 forms the heat-generating section 9 described above. Then, the plurality of exposed regions (the heat-generating sections 9) are disposed in a row on the raised portion 13b of the heat storage layer 13, as shown in FIGS. 1, 2, and 4. The plurality of heat-generating sections 9 are described in a simplified manner in FIGS. 1 and 4 for convenience of explanation. However, the heat-generating sections 9 are disposed at a density in the range of 180 to 2400 dpi (dot per inch) or the like, for example.

The electrical resistance layer 15 is formed of, for example, TaN-based, TaSiO-based, TaSiNO-based, TiSiO-based, TiSiCO-based, or NbSiO-based material or the like having relatively high electrical resistance. For this reason, when voltage is applied between the common electrode wiring 17 and the individual electrode wiring 19 which will be described later, so that an electric current is supplied to the heat-generating section 9, the heat-generating section 9 generates heat due to Joule heat generation.

As shown in FIGS. 1 to 4, on the upper surface of the electrical resistance layer 15 (in more detail, the upper surfaces of the above-described interposition regions), the common electrode wiring 17, a plurality of individual electrode wirings 19, and a plurality of IC-FPC connection wirings 21 are disposed. Each of the common electrode wiring 17, the individual electrode wiring 19, and the IC-FPC connection wiring 21 is formed of a material having electric conductivity and formed of, for example, any one kind of metal among aluminum, gold, silver, and copper, or alloys of these.

The common electrode wiring 17 is an element for connecting the plurality of heat-generating sections 9 and the FPC 5. As shown in FIG. 4, the common electrode wiring 17 has a main wiring section 17a extending along a long side (in the illustrated example, a left long side) on one side of the substrate 7, two sub-wiring sections 17b respectively extending along short sides on one side and the other side of the substrate 7 and connected at one end portion (in the illustrated example, a left end portion) to the main wiring section 17a, and a plurality (in the illustrated example, 24 pieces) of lead sections 17c individually extending toward each heat-generating section 9 from the main wiring section 17a and each connected at a leading end portion (in the illustrated example, a right end portion) to each heat-generating section 9. Then, the other end portions (in FIG. 1, right end portions) of the sub-wiring sections 17b are connected to the FPC 5, whereby the common electrode wiring 17 electrically connects the FPC 5 and each heat-generating section 9 to each other.

The plurality of individual electrode wirings 19 are provided for connecting the respective heat-generating sections 9 and the drive ICs 11. As shown in FIGS. 2 and 4, each individual electrode wiring 19 individually extends in a strip shape toward a placement region of the drive IC 11 from each heat-generating sections 9 such that one end portion (in the illustrated example, a left end portion) is connected to the heat-generating section 9 and the other end portion (in the illustrated example, a right end portion) is disposed in the placement region of the drive IC 11. Then, the other end portion of each individual electrode wiring 19 is connected to the drive IC 11, whereby each heat-generating section 9 and the drive IC 11 are electrically connected to each other. In more detail, the individual electrode wirings 19 divide the plurality of heat-generating sections 9 into a plurality (in the illustrated example, three pieces) of groups and electrically connect each group of heat-generating sections 9 to the drive IC 11 disposed corresponding to each group.

The plurality of IC-FPC connection wirings 21 are elements for connecting the drive ICs 11 and the FPC 5. As shown in FIGS. 2 to 4, each IC-FPC connection wiring 21 extends in a strip shape such that one end portion (in the illustrated example, a left end portion) is disposed in the placement region of the drive IC 11 and the other end portion (in the illustrated example, a right end portion) is disposed in the vicinity of a long side (in the illustrated example, a right long side) on the other side of the substrate 7. Then, each of the plurality of IC-FPC connection wirings 21 is connected at one end portion thereof to the drive IC 11 and at the other end portion to the FPC 5, thereby electrically connecting the drive IC 11 and the FPC 5 to each other.

In more detail, the plurality of IC-FPC connection wirings 21 connected to each drive IC 11 are composed of a plurality of wirings having different functions. Specifically, the plurality of IC-FPC connection wirings 21 are composed, for example, of IC power supply wirings for supplying power currents for operating the drive ICs 11, ground electrode wirings for maintaining the drive ICs 11 and the individual electrode wirings 19 connected to the drive ICs 11 at a ground potential (for example, in a range of 0 V to 1 V), and IC control wirings for supplying electric signals for operating the drive ICs 11 so as to control ON-OFF states of switching elements (described later) in the drive ICs 11.

As shown in FIG. 4, the drive IC 11 is disposed corresponding to each group of the plurality of heat-generating sections 9 and connected to the other end portion (in the illustrated example, a right end portion) of each of the individual electrode wirings 19 and one end portion (in the illustrated example, a left end portion) of each of the IC-FPC connection wirings 21. The drive IC 11 is an element for controlling an energizing state of each heat-generating section 9, and a publicly known drive IC can be used which has a plurality of switching elements in the inside and is turned into an energizing state when each switching element is in an ON state and turned into a non-energizing state when each switching element is in an OFF state.

Each drive IC 11 has a plurality of switching elements (not shown) disposed in the inside so as to correspond to the respective individual electrode wirings 19 connected to each drive IC 11. Then, as shown in FIG. 2, in each drive IC 11, a connection terminal 11a (hereinafter referred to as a first connection terminal 11a) on one side (in the illustrated example, the left side) connected to each switching element (not shown) is connected to the individual electrode wiring 19 and a connection terminal 11b (hereinafter referred to as a second connection terminal 11b) on the other side (in the illustrated example, the right side) connected to each switching element is connected to the above-described ground electrode wiring of the IC-FPC connection wiring 21. In this way, when each switching element of the drive IC 11 is in an ON state, the individual electrode wiring 19 and the ground electrode wiring of the IC-FPC connection wiring 21 connected to each switching element are electrically connected to each other.

The electrical resistance layer 15, the common electrode wiring 17, the individual electrode wiring 19, and the IC-FPC connection wiring 21 are formed, for example, by sequentially laminating the material layers respectively constituting them on the heat storage layer 13 by a well-known conventional thin-film forming technique such as sputtering, for example, and then processing the laminated body into a given pattern by using a well-known conventional photolithography technique, an etching technique, or the like.

As shown in FIGS. 1 to 4, the first protective layer 25 which covers the heat-generating sections 9, a portion of the common electrode wiring 17, and a portion of each of the individual electrode wirings 19 is formed on or above the heat storage layer 13 formed on the upper surface of the substrate 7. In the illustrated example, the first protective layer 25 is disposed so as to cover a left region of the upper surface of the heat storage layer 13. The first protective layer 25 is provided for protecting the covered regions of the heat-generating sections 9, the common electrode wiring 17, and the individual electrode wirings 19 from corrosion due to attachment of moisture or the like contained in the air, or abrasion due to contact with a recording medium which is to be printed. The first protective layer 25 can be formed of, for example, SiC-based, SiN-based, SiO-based, and SiON-based materials or the like. Further, the first protective layer 25 can be formed by using, for example, a well-known conventional thin-film forming technique such as a sputtering method or an evaporation method, or a thick-film forming technique such as a screen printing method. Further, the first protective layer 25 may be formed by laminating a plurality of material layers. In addition, in FIGS. 1 and 4, for convenience of explanation, formation regions of the first protective layer 25 and a second protective layer 27 (described later) are shown by two-dot chain lines and illustration of these is omitted.

Further, as shown in FIGS. 1 to 4, the second protective layer 27 which partially covers the common electrode wiring 17, the individual electrode wirings 19, and the IC-FPC connection wirings 21 is disposed above the heat storage layer 13 formed on the upper surface of the substrate 7. In the illustrated example, the second protective layer 27 is disposed so as to partially cover a region further on the right side than the first protective layer 25 of the upper surface of the heat storage layer 13. The second protective layer 27 is provided for protecting the covered regions of the common electrode wiring 17, the individual electrode wirings 19, and the IC-FPC connection wirings 21 from oxidation due to contact with the air, or corrosion due to attachment of moisture or the like contained in the air. In addition, the second protective layer 27 is formed so as to overlap an end portion of the first protective layer 25, as shown in FIG. 2, in order to further ensure protection of the common electrode wiring 17 and the individual electrode wirings 19. The second protective layer 27 can be formed of, for example, a resin material such as epoxy resin or polyimide resin. Further, the second protective layer 27 can be formed by using, for example, a thick-film forming technique such as screen printing.

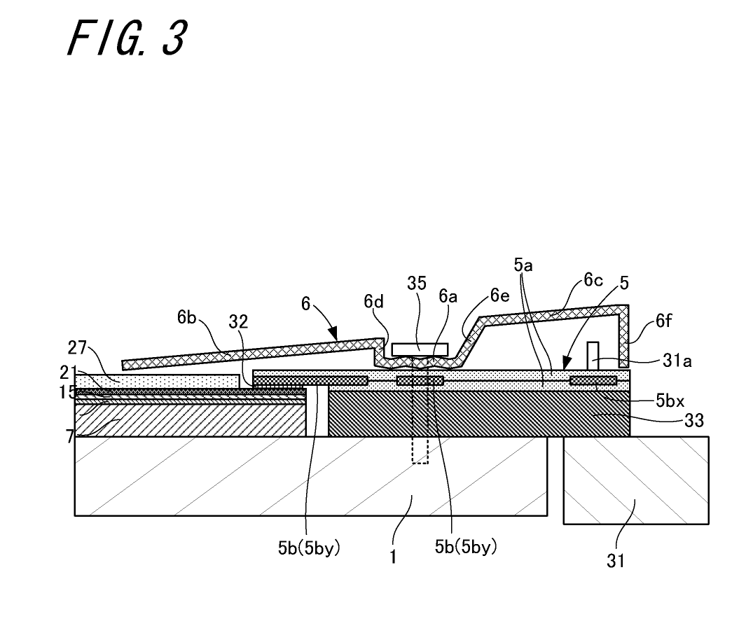

In addition, as shown in FIGS. 3 and 4, the sub-wiring sections 17b of the common electrode wiring 17 and end portions of the IC-FPC connection wirings 21, to which the FPC 5 (described later) is connected, are exposed from the second protective layer 27, thereby being made such that the FPC 5 (described later) is connected thereto.

Further, in the second protective layer 27, an opening portion 27a (refer to FIG. 2) for exposing end portions of the individual electrode wiring 19 and the IC-FPC connection wiring 21, to which the drive IC 11 is connected, is formed, and these wirings are connected to the drive IC 11 through the opening portion 27a. Further, in a state where the drive IC 11 is connected to the individual electrode wiring 19 and the IC-FPC connection wiring 21, for protection of the drive IC 11 itself and protection of connection portions of the drive IC 11 and these wirings, the drive IC 11 is sealed by being covered by a covering member 29 made of resin such as epoxy resin or silicone resin.

The FPC 5 extends along the arrangement direction of the plurality of heat-generating sections 9 of the head base 3, as shown in FIGS. 3 and 4, and has a rectangular shape in plan view, as shown in FIG. 4. The FPC 5 is connected to the sub-wiring sections 17b of the common electrode wiring 17 and each IC-FPC connection wiring 21, as described above. The FPC 5 is a well-known flexible printed circuit board in which a plurality of electrically-conducting wirings is wired in the inside of an insulating resin layer, and is made such that each electrically-conducting wiring is electrically connected to an external power-supply device and an external control device (none of which is shown) or the like through a connector 31.

In more detail, as shown in FIGS. 3 and 4, in the FPC 5, each electrically-conducting wiring 5b formed in the inside of an insulating resin layer 5a is exposed at an end portion on the head base 3 side and connected to an end portion of the sub-wiring section 17b of the common electrode wiring 17 and an end portion of each IC-FPC connection wiring 21 by a conductive joining material, for example, a solder material, or a joint material 32 (refer to FIG. 3) made of an anisotropic conductive material like in which conductive particles are mixed in electrically insulating resin (ACF). In addition, in FIG. 4, two electrically-conducting wirings 5b connected to the end portions of the sub-wiring sections 17b of the common electrode wiring 17 are shown by broken lines as power supply wirings 5bx. Further, in FIG. 4, in a plurality of electrically-conducting wirings 5b connected to the end portions of the respective IC-FPC connection wirings 21, a few (in the illustrated example, five) electrically-conducting wirings among the plurality of electrically-conducting wirings 5b connected to the above-described IC control wirings for supplying electric signals for operating the drive ICs 11 are schematically shown by broken lines as signal wirings 5by. Further, each of the power supply wiring 5bx and the signal wiring 5by has a first region 5bs extending along the longitudinal direction (in FIG. 4, the up and down direction) of the FPC 5.

Then, if each electrically-conducting wiring 5b of the FPC 5 is electrically connected to the external power-supply device and the external control device (none of which is shown) or the like through the connector 31, the common electrode wiring 17 is electrically connected to a positive side terminal of the power-supply device maintained at a positive potential (for example, in a range of 20 V to 24 V), and the individual electrode wirings 19 are electrically connected to a negative side terminal of the power-supply device maintained at a ground potential (for example, in a range of 0 V to 1 V), through the drive ICs 11 and the ground electrode wirings of the IC-FPC connection wirings 21. For this reason, when the switching element of the drive IC 11 is in an ON state, an electric current is supplied to the heat-generating section 9, so that the heat-generating section 9 generates heat.

Further, similarly, if each electrically-conducting wiring 5b of the FPC 5 is electrically connected to the external power-supply device and the external control device (none of which is shown) or the like through the connector 31, the above-described IC power supply wiring of the IC-FPC connection wiring 21 is electrically connected to the positive side terminal of the power-supply device maintained at a positive potential, similarly to the common electrode wiring 17. In this way, a power current for operating the drive IC 11 is supplied to the drive IC 11 according to a difference in potential between the IC power supply wiring and the ground electrode wiring of the IC-FPC connection wiring 21 to which the drive IC 11 is connected. Further, the above-described IC control wiring of the IC-FPC connection wiring 21 is electrically connected to an external control device which performs control of the drive IC 11. In this way, an electric signal sent from the control device is supplied to the drive IC 11. By operating the drive IC 11 so as to control the ON-OFF state of each switching element in the drive IC 11 by the electric signal, it is possible to make the respective heat-generating sections 9 selectively generate heat.

A reinforcing plate 33 made of resin such as polyimide resin or glass epoxy resin is disposed between the FPC 5 and the radiator 1. The reinforcing plate 33 is adhered to the lower surface of the FPC 5 by a double-sided tape, an adhesive, or the like (not shown), thereby acting so as to reinforce the FPC 5. Further, the reinforcing plate 33 is adhered to the upper surface of the radiator 1 by a double-sided tape, an adhesive, or the like (not shown), whereby the FPC 5 is fixed on or above the radiator 1.

The cover member 6 is an element for protecting a protruding object (for example, as shown in FIG. 3, a connection terminal 31a for connecting the electrically-conducting wiring 5b of the FPC 5 to the connector 31) which protrudes from the upper surface of the FPC 5, or making the protruding object not come into contact with the recording medium which is conveyed on the head base 3.

As shown in FIGS. 1 and 3, the cover member 6 is disposed above the FPC 5 so as to cover the entire upper surface of the FPC 5. Further, the entirety of the face of the cover member 6 located on the FPC 5 side, which is located above the FPC 5, is composed of a plurality of inclined surfaces which are inclined with respect to the face on the cover member 6 side of the electrically-conducting wiring 5b of the FPC 5 in the cross-section in a direction orthogonal to the arrangement direction of the plurality of heat-generating sections 9 of the head base 3, as shown in FIG. 3. In this embodiment, the cover member 6 is formed such that the inclined surface of the cover member 6 is inclined at two degrees or more with respect to the face on the cover member 6 side of the electrically-conducting wiring 5b. This is because if the inclination angle of the inclined surface is smaller than two degrees, as in an example in the related art, a parallel plate resonance is easily generated between the electrically-conducting wiring 5b of the FPC 5 and the face on the FPC 5 side of the cover member 6, which is located above the electrically-conducting wiring 5b. In addition, although the FPC 5 has flexibility, since the FPC 5 is adhered onto the flat upper surface of the reinforcing plate 33, as shown in FIG. 3, the faces of the plurality of electrically-conducting wirings 5b of the FPC 5 located on the cover member 6 side are disposed in substantially the same plane.

In more detail, the cover member 6 has a fixed section 6a for fixing the cover member 6 on or above the FPC 5, a first inclined section 6b which is located further to the head base 3 side than the fixed section 6a, and a second inclined section 6c which is located on the opposite side to the first inclined section 6b with respect to the fixed section 6a, as shown in FIGS. 1 and 3.

The first inclined section 6b has a flat plate shape, extends along the arrangement direction of the plurality of heat-generating sections 9, and is formed over a range from above the IC-FPC connection wirings 21 of the head base 3 to above the FPC 5. In this way, a connection portion between the FPC 5 and the head base 3 is protected by the first inclined section. Further, the first inclined section 6b is inclined in such a manner that the heights of the upper surface and the lower surface of the first inclined section 6b become higher with the fixed section 6a approaching, as shown in FIG. 3. In addition, in this embodiment, a guide surface for guiding the recording medium which is conveyed on the thermal head X is formed by the inclined surface which is formed by the upper surface of the first inclined section 6b.

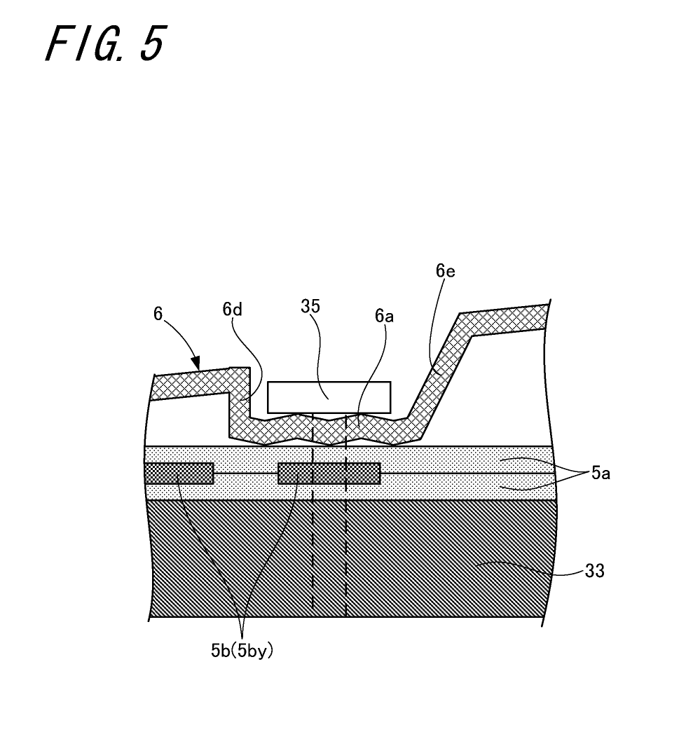

The fixed section 6a extends along the arrangement direction of the plurality of heat-generating sections 9, as shown in FIG. 1, and has a waved shape when viewed in cross section, as shown in FIG. 3. In addition, the fixed section 6a shown in FIG. 3 and a region the vicinity thereof are shown in an enlarged manner in FIG. 5. The fixed section 6a is located further to the lower side than an end portion on the fixed section 6a side of the first inclined section 6b and joined to the first inclined section 6b by a first joint section 6d extending in the up and down direction. The cover member 6 is fixed on or above the FPC 5 by tightening a fixing screw 35 penetrating the fixed section 6a, the FPC 5, and the reinforcing plate 33 to a threaded hole (not shown) formed in the radiator 1 in a state where the fixed section 6a comes into contact with the upper surface of the FPC 5. Further, the fixing screw 35 acts so as to allow static electricity generated in the cover member 6 to escape to the radiator 1. Further, for example, in a case where a thermal printer is constituted using the thermal head X, by making a configuration so as to earth the radiator 1 by electrically connecting the radiator 1 to the housing or the like of the thermal printer, it is possible to discharge static electricity generated in the cover member 6.

The second inclined section 6c is located further to the upper side than the fixed section 6a and joined to the fixed section 6a by a second joint section 6e which extends upward from the fixed section 6a and is inclined toward the second inclined section 6c. The second inclined section 6c extends to above an end portion on the side where the connecter 31 is disposed, of the FPC 5, while being inclined in such a manner that the heights of the upper surface and the lower surface of the second inclined section 6c become higher with increasing distance from the fixed section 6a. In this way, the protruding object (for example, the connection terminal 31a) protruding from the upper surface of the FPC 5 is protected by the second inclined section 6c. Further, to an end portion on the side away from the fixed section 6a of the second inclined section 6c, a third joint section 6f extending downward from the end portion is joined.

Further, the cover member 6 is formed of a material having electric conductivity and can be formed of a metal material such as stainless steel or aluminum, for example. In this embodiment, the inclined surfaces which are the face on the FPC 5 side of the cover member 6 are formed by performing bending on a metal plate made of stainless steel or the like. In this manner, if the inclined surfaces of the face on the FPC 5 side of the cover member 6 are formed by the bending of the metal plate, the face on the opposite side to the face on the FPC 5 side of the cover member 6 can be inclined in the same manner. For this reason, as in this embodiment, in a case where the guide surface for guiding the recording medium which is conveyed on the thermal head X is formed by the upper surface of the first inclined surface 6b of the cover member 6, it is possible to form the guide surface for the recording medium by the first inclined surface 6b, simultaneously with forming the inclined surfaces of the face on the FPC 5 side of the cover member 6.

Further, in a case where a thermal printer is constituted by applying the thermal head X, the thermal head X is disposed such that the arrangement direction of the plurality of heat-generating sections 9 is orthogonal to a conveyance direction of the recording medium which is to be printed. Then, while pressing the recording medium against the heat-generating sections 9 of the thermal head X (in more detail, the first protective layer 25 on the heat-generating sections 9) by a platen roller or the like, the heat-generating sections 9 are made to selectively generate heat while conveying the recording medium. In this way, desired printing is performed on the recording medium. In addition, a direction orthogonal to the conveyance direction of the recording medium becomes a main scanning direction.

According to the thermal head X of this embodiment, the entirety of the face on the FPC 5 side of the cover member 6, which is located above the FPC 5, is composed of the plurality of inclined surfaces which are inclined with respect to the face on the cover member 6 side of the electrically-conducting wiring 5b of the FPC 5, in the cross section in a direction orthogonal to the arrangement direction of the plurality of heat-generating sections 9 of the head base 3, as shown in FIG. 3. For this reason, the face on the FPC 5 side of the cover member 6 is inclined with respect to the face on the cover member 6 side of the electrically-conducting wiring 5b. In this way, an electric current and an electric signal which flow through the electrically-conducting wirings 5b do not flow parallel to the face on the FPC 5 side of the cover member 6 located above the electrically-conducting wirings 5b. For this reason, generation of parallel plate resonance between the electrically-conducting wiring 5b and the face on the FPC 5 side of the cover member 6 can be reduced, so that it is possible to reduce generation of radiation noise of a specific frequency due to the parallel plate resonance. As a result, according to the thermal head X of this embodiment, it is possible to reduce occurrence of electromagnetic interference or occurrence of a malfunction.

In addition, since generation of radiation noise due to such parallel plate resonance becomes more pronounced in a case where a high-frequency electric signal flows through a circuit board with the faster printing speed of a thermal head, for example, in particular, in a case where an electric signal including a high-frequency electric signal having a frequency of 30 MHz or more flows through an FPC, the radiation noise reduction effect by the invention becomes more pronounced. Examples of such a high-frequency electric signal include a clock signal which is supplied to the drive IC 11.

One embodiment of the invention has been described above. However, the invention is not limited to the above-described embodiment and various changes can be made without departing from the gist of the invention.

In the thermal head X of the above-described embodiment, as shown in FIGS. 1 and 3, the cover member 6 is disposed above the FPC 5 so as to cover the entire upper surface of the FPC 5. However, the invention is not limited thereto. For example, although not shown in the drawings, the cover member 6 may be disposed above the FPC 5 so as to cover a region of at least a portion of the upper surface of the FPC 5.

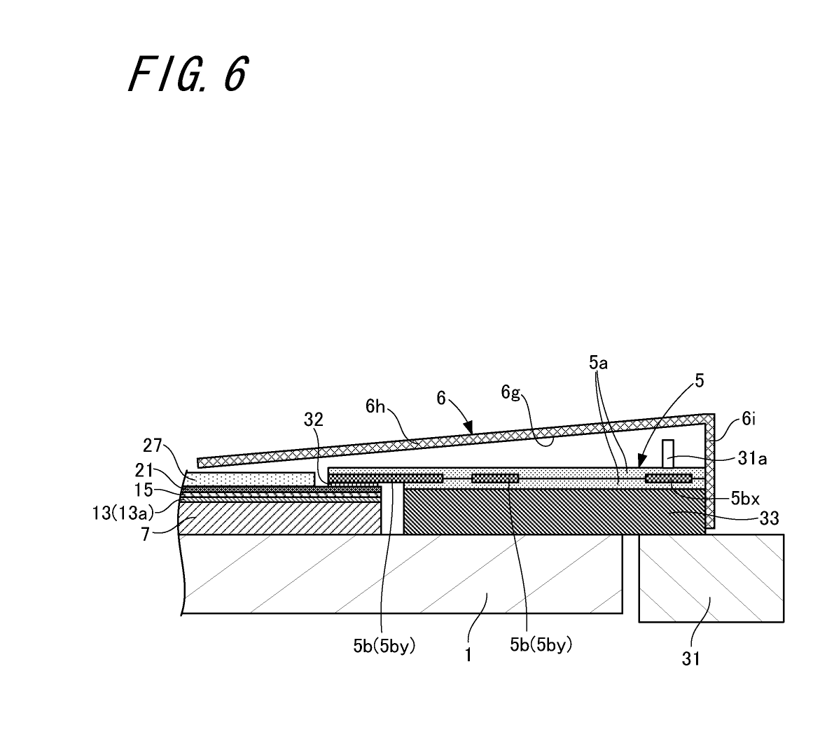

Further, in the thermal head X of the above-described embodiment, the entirety of the face on the FPC 5 side of the cover member 6, which is located above the FPC 5, is composed of the plurality of inclined surfaces which are inclined with respect to the face on the cover member 6 side of the electrically-conducting wiring 5b of the FPC 5, in the cross section in a direction orthogonal to the arrangement direction of the plurality of heat-generating sections 9 of the head base 3. However, the invention is not limited thereto. For example, the cover member 6 may be formed such that the entirety of the face on the FPC 5 side of the cover member 6, which is located above the FPC 5, is composed of a single inclined surface 6g, as shown in FIG. 6, for example. In this case, the cover member 6 can be formed by a first inclined section 6h forming the inclined surface 6g, and a first joint section 6i extending downward from an end portion of the first inclined section 6h, as shown in FIG. 6, for example. In this case, it is acceptable if the cover member 6 is fixed by making the first joint section 6i adhere to the reinforcing plate 33 by a double-sided tape, an adhesive, or the like (not shown).

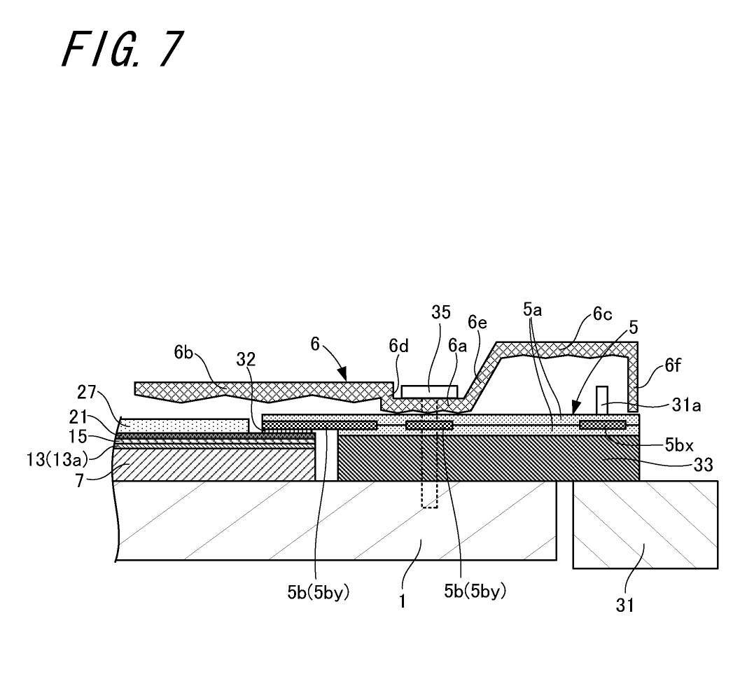

Further, for example, in the above-described embodiment, as shown in FIG. 3, only the fixed section 6a of the cover member 6 is formed in a waved shape composed of a plurality of inclined surfaces when viewed in cross section. However, in addition to this, each of the first inclined section 6b and the second inclined section 6c may be formed in a waved shape composed of a plurality of inclined surfaces when viewed in cross section. Further, as shown in FIG. 7, only the faces on the FPC 5 side of the fixed section 6a, the first inclined section 6b, and the second inclined section 6c of the cover member 6 may be made to be inclined surfaces and the faces on the opposite side to the faces on the FPC 5 side may be parallel to the faces on the cover member 6 side of the electrically-conducting wirings 5b of the FPC 5. The cover member 6 shown in FIG. 7 can be formed, for example, by extrusion molding of a metal material such as aluminum.

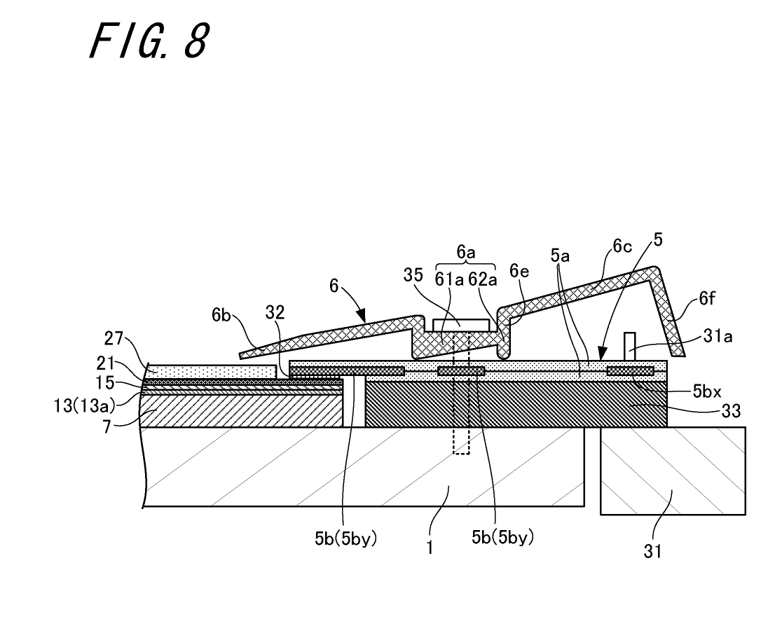

Further, in the thermal head X of the above-described embodiment, the fixed section 6a of the cover member 6 has a waved shape when viewed in cross section, as shown in FIG. 3. However, the invention is not limited thereto. For example, the fixed section 6a of the cover member 6 may be composed of a first fixed section 61a and a second fixed section 62a when viewed in cross section, as shown in FIG. 8. The first fixed section 61a is inclined in such a manner that the face thereof on the FPC 5 side is located upwardly as it goes toward the second inclined section 6c side from the first inclined section 6b side. Further, in the first fixed section 61a, an end portion on the first inclined section 6b side of the face on the FPC 5 side has a curved surface shape and the end portion is in contact with the FPC 5. In the second fixed section 62a, the face thereof on the FPC 5 side has a curved surface shape and the face is in contact with the FPC 5. In the fixed section 6a of the cover member 6 shown in FIG. 8, in this manner, by forming the face on the FPC 5 side by a plurality of inclined surfaces including curved surfaces, the face on the FPC 5 side is inclined with respect to the face on the fixed section 6a side of a first region 5bs of a signal wiring 5by. In addition, in the cover member 6 shown in FIG. 8, the first inclined section 6b is directly joined to the fixed section 6a. Further, the second joint section 6e which joins the fixed section 6a and the second inclined section 6c to each other extends upward from the upper surface of the fixed section 6a. Further, the third joint section 6f joined to the end portion on the side away from the fixed section 6a of the second inclined section 6c is inclined so as to become more distant from the fixed section 6a as it goes downward from the end portion.

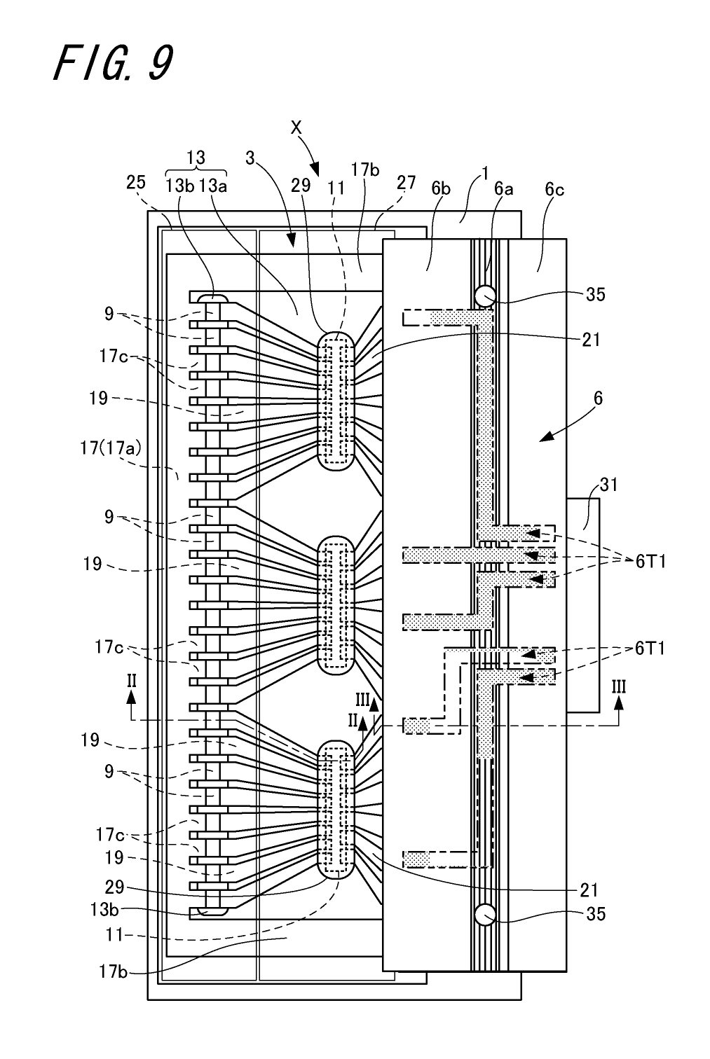

Further, in the thermal head X of the above-described embodiment, the entirety of the face on the FPC 5 side of the cover member 6 is composed of a plurality of inclined surfaces which are inclined with respect to the face on the cover member 6 side of the FPC 5. However, the invention is not limited thereto. In the thermal head X of the above-described embodiment, as shown in FIG. 9, the face on the FPC 5 side of the cover member 6 has a first inclined region 6T1 which is located above the signal wiring 5by for supplying an electric signal for operating the drive IC 11. In FIG. 9, the position of the first inclined region 6T1 of the face on the FPC 5 side of the cover member 6 is shown in a speckled pattern. For example, the face on the FPC 5 side of the cover member 6 may be formed in various shapes such that at least the first inclined region 6T1 is composed of at least one inclined surface which is inclined with respect to the face on the first inclined region 6T1 side of the signal wiring 5by. Also by this, similarly to the thermal head X of the above-described embodiment, since an electric signal flowing through the signal wiring 5by does not flow parallel to the first inclined region 6T1 of the cover member 6, which is located above the signal wiring 5by, generation of parallel plate resonance between the signal wiring 5by and the first inclined region 6T1 of the cover member 6 can be reduced. Since a high-frequency electric signal flows through the signal wiring 5by, as described above, parallel plate resonance is easily generated. For this reason, by reducing generation of parallel plate resonance due to the electric signal of the signal wiring 5by, it is possible to effectively reduce the generation of the parallel plate resonance.

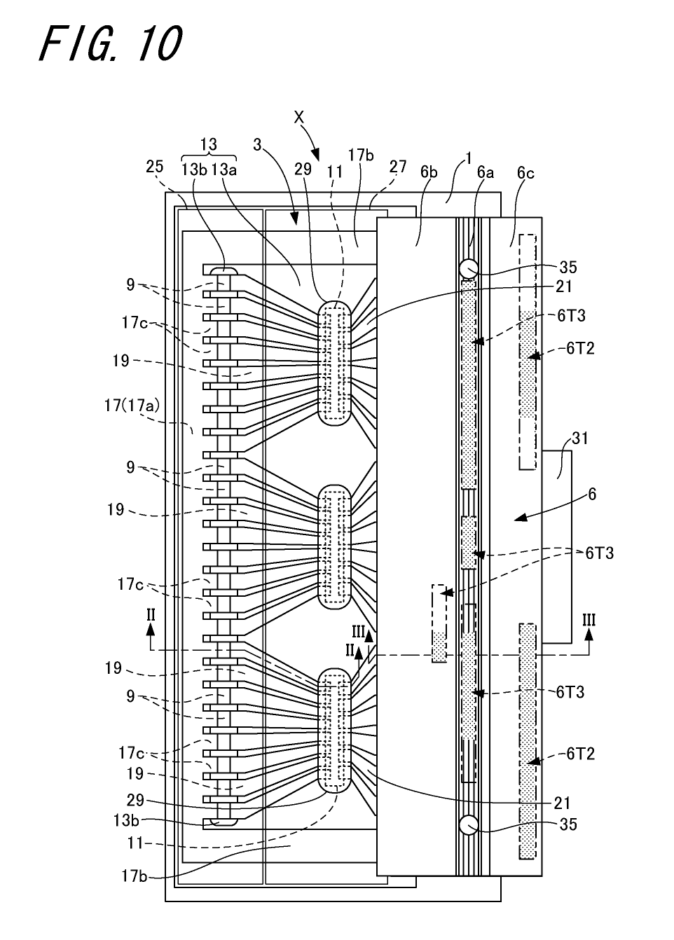

Or, in the thermal head X of the above-described embodiment, as shown in FIG. 10, the face on the FPC 5 side of the cover member 6 has a second inclined region 6T2 located above the first region 5bs of a power supply wiring 5bx, and a third inclined region 6T3 located above the first region 5bs of the signal wiring 5by. The second inclined region 6T2 extends along the first region 5bs of the power supply wiring 5bx. The third inclined region 6T3 extends along the first region 5bs of the signal wiring 5by. In FIG. 10, the positions of the second inclined region 6T2 and the third inclined region 6T3 of the face on the FPC 5 side of the cover member 6 are shown in speckled patterns. For example, the face on the FPC 5 side of the cover member 6 may be formed in various shapes such that at least the second inclined region 6T2 is composed of at least one inclined surface which is inclined with respect to the face on the second inclined region 6T2 side of the first region 5bs of the power supply wiring 5bx and at least the third inclined region 6T3 is composed of at least one inclined surface which is inclined with respect to the face on the third inclined region 6T3 side of the first region 5bs of the signal wiring 5by. Also by this, similarly to the thermal head X of the above-described embodiment, since an electric current and an electric signal which flow through the first regions 5bs of the power supply wiring 5bx and the signal wiring 5by do not flow parallel to the second inclined region 6T2 and the third inclined region 6T3 of the cover member 6, generation of parallel plate resonance between the first regions 5bs and the second inclined region 6T2 and the third inclined region 6T3 of the cover member 6 can be reduced. Since the first regions 5bs of the power supply wiring 5bx and the signal wiring 5by extend along the longitudinal direction of the FPC 5 and the lengths of the first regions 5bs are long, parallel plate resonance is easily generated. For this reason, by reducing generation of parallel plate resonance due to the electric current and the electric signal which flow the first regions 5bs, it is possible to effectively reduce the generation of the parallel plate resonance.

Further, in the thermal head X of the above-described embodiment, the common electrode wiring 17 and the IC-FPC connection wirings 21 disposed over the substrate 7 of the head base 3 are electrically connected to the external power-supply device and the external control device or the like through the FPC 5. However, the invention is not limited thereto and the common electrode wiring 17 and the IC-FPC connection wirings 21 may be connected to the external power-supply device and the external control device or the like through various circuit boards. For example, various wirings of the head base 3 may be electrically connected to the external power supply device or the like through a hard printed circuit board rather than a circuit board having flexibility like the FPC 5. In this case, for example, it is favorable if the common electrode wiring 17 and the IC-FPC connection wirings 21 of the head base 3 are connected to the printed wirings of a printed circuit board through wire bonding or the like. Further, also in this case, the cover member 6 is disposed above the hard printed circuit board, similarly to the case of the FPC 5.

Further, in the thermal head X of the above-described embodiment, as shown in FIGS. 1 and 2, the drive ICs 11 are disposed on or above the substrate 7 of the head base 3. However, the invention is not limited thereto. For example, although not shown in the drawings, a hard printed circuit board may be disposed in place of the FPC 5 as described above and drive ICs may be disposed on or above the printed circuit board. In this case, for example, it is favorable if the common electrode wiring 17 and the individual electrode wirings 19 of the head base 3 are connected to the printed wirings of the printed circuit board through wire bonding or the like.

### REFERENCE SIGNS LIST

X: Thermal head

1: Radiator

3: Head base

5: Flexible printed circuit board (Circuit board)

5b: Electrically-conducting wiring

5bx: Power supply wiring (Electrically-conducting wiring for supplying electric current for making heat-generating section generate heat)

5by: Signal wiring (Electrically-conducting wiring for supplying electric signal for operating drive IC)

5bs: First region (Region extending along longitudinal direction of circuit board)

6: Cover member

6a: Fixed section

6b: First inclined section

6c: Second inclined section

6T1: First inclined region (Region located above the signal wiring in face on circuit board side of cover member)

6T2: Second inclined region (Region located above first region of power supply wiring in face on circuit board side of cover member)

6T3: Third inclined region (Region located above first region of signal wiring in face on circuit board side of cover member)

7: Substrate

9: Heat-generating section

11: Drive IC

1. A thermal head, comprising:
a head base having a substrate and a plurality of heat-generating sections arranged on or above the substrate;
a circuit board;
a drive IC disposed on or above the substrate or on or above the circuit board, the drive IC controlling energizing states of the heat-generating sections; and
a cover member having electric conductivity, disposed at least above the circuit board,
the circuit board having a plurality of signal wirings for supplying electric signals for operating the drive IC,
a face on a circuit board side of the cover member having an inclined region located above the signal wiring, and
the inclined region being composed of at least one inclined surface which is inclined with respect to a face on an inclined region side of the signal wiring.

2. The thermal head according to claim 1, wherein the circuit board extends along an arrangement direction of the plurality of heat-generating sections, and
the signal wiring has a first region extending along a longitudinal direction of the circuit board.

3. The thermal head according to claim 1, wherein the cover member has a fixed section for fixing the cover member on or above the circuit board,
the face on the circuit board side of the fixed section has the inclined region located above the signal wiring, and
the inclined region of the fixed section is composed of at least one inclined surface which is inclined with respect to the face on the inclined region side of the signal wiring.

4. A thermal head, comprising:
a head base having a substrate and a plurality of heat-generating sections arranged on or above the substrate;
a circuit board extending along an arrangement direction of the plurality of heat-generating sections;
a drive IC disposed on or above the substrate or on or above the circuit board, the drive IC controlling energizing states of the heat-generating sections; and
a cover member having electric conductivity, disposed at least above the circuit board,
the circuit board having an electrically-conducting wiring which includes at least one of power supply wirings for supplying electric currents for making the plurality of heat-generating sections generate heat and signal wirings for supplying electric signals for operating the drive IC,
the electrically-conducting wiring having a first region extending along a longitudinal direction of the circuit board,
a face on a circuit board side of the cover member having an inclined region located above the first region of the electrically-conducting wiring, and
the inclined region being composed of at least one inclined surface which is inclined with respect to a face on an inclined region side of the first region.

5. The thermal head according to claim 4, wherein the cover member has a fixed section for fixing the cover member on or above the circuit board,
the face on the circuit board side of the fixed section has an inclined region located above the first region of the electrically-conducting wiring, and
the inclined region of the fixed section is composed of at least one inclined surface which is inclined with respect to the face on the inclined region side of the first region.

6. The thermal head according to claim 1, wherein the cover member forms a guide surface for guiding a recording medium which is to be printed, by a face on an opposite side to the inclined surface.

7. The thermal head according to claim 4, wherein the cover member forms a guide surface for guiding a recording medium which is to be printed, by a face on an opposite side to the inclined surface.
